(19) United States
(12) Patent Application Publication
(10) Pub. No.: US 2001/0049845 A1
(43) Pub. Date: Dec. 13, 2001

(54) Apparatus for raising and lowering a vehicle jack

(76) Inventor: Ralph Lewis, Dolton, IL (US)

Correspondence Address: Matthew J. Peirce, Esq., 1550 Starlight Canyon Avenue, Las Vegas, NV, 89123, US

(21) Appl. No.: 09/878,065

(22) Filed: Jun. 7, 2001

Related U.S. Application Data
(60) Provisional application No. 60/210,026, filed on Jun. 8, 2000.

(51) Int. Cl. B25F 1/00

(52) U.S. Cl. 7/100

(57) ABSTRACT

The present invention concerns that of a new and improved apparatus which would allow a user to more easily raise and lower a jack of a vehicle. Presently, it is awkward for most people to use the jack handle that comes as a standard part of all vehicles. The jack handle that presently comes with vehicles can be turned a little over 180 degrees, at which time, the handle of the jack handle must be brought back toward the person's body, at which time, the jack handle is attached to the jack again and the motion is repeated. A traditional jack handle must be constantly used, detached, reattached, and used again approximately 20-30 times before the jack would be an appropriate level for a user to change a tire or perform other desired car repairs or alterations. The present invention would combine the beneficial aspects of a jack handle, along with the beneficial aspects of a ratchet wrench, to allow a user to properly raise or lower a ratchet wrench without ever having the need to attach or detach the present invention from the jack until the necessary height had been reached.

### I. BACKGROUND OF THE INVENTION

The present invention concerns that of a new and improved apparatus which would allow a user to more easily raise and lower a vehicle jack.

### II. DESCRIPTION OF THE PRIOR ART

U.S. Pat. No. 5,215,287, issued to Leski, discloses a vehicle which is a vehicle lifting jack which is a modification of prior art scissor jack by replacing its top member with a wheel support plate, which has restricted pivotable movement.

U.S. Pat. No. 4,856,747, issued to Gano, discloses a ratchet jack stand assembly intended for supporting a raised load which is formed entirely of stamped steel components and is free of any spring-biased members.

U.S. Pat. No. 3,813,967, issued to De Haven, discloses a hand held unidirectional socket ratchet wrench and more particularly to a wrench useful for securing in place or unscrewing the nuts or lag screws which reliable secure vehicle wheels to the hub.

### III. SUMMARY OF THE INVENTION

The present invention concerns that of a new and improved apparatus which would allow a user to more easily raise and lower a vehicle jack. Presently, it is awkward for most people to use the jack handle that comes as a standard part of all vehicles. The jack handle that presently comes with vehicles can be turned a little over 180 degrees, at which time, the handle of the jack handle must be brought back toward the person's body, at which time, the jack handle is attached to the jack again and the motion is repeated. A traditional jack handle must be constantly used, detached, re-attached, and used again approximately 20-30 times before the jack would be an appropriate level for a user to change a tire or perform other desired car repairs or alterations. The present invention would combine the beneficial aspects of a jack handle, along with the beneficial aspects of a ratchet wrench, to allow a user to properly raise or lower a ratchet wrench without ever having the need to attach or detach the present invention from the jack until the necessary height had been reached.

There has thus been outlined, rather broadly, the more important features of an apparatus for raising and lowering a vehicle jack in order that the detailed description thereof that follows may be better understood and in order that the present contribution to the art may be better appreciated. There are, of course, additional features of the apparatus for raising and lowering a vehicle jack that will be described hereinafter and which will form the subject matter of the claims appended hereto.

In this respect, before explaining at least one embodiment of the apparatus for raising and lowering a vehicle jack in detail, it is to be understood that the apparatus for raising and lowering a vehicle jack is not limited in its application to the details of construction and to the arrangements of the components set forth in the following description or illustrated in the drawings. The apparatus for raising and lowering a vehicle jack is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present apparatus for raising and lowering a vehicle jack. It is important, therefore, that the claims be regarded as including such equivalent constructions insofar as they do not depart from the spirit and scope of the present invention.

It is therefore an object of the present invention to provide an apparatus for raising and lowering a vehicle jack which has all of the advantages of the prior art and none of the disadvantages.

It is another object of the present invention to provide an apparatus for raising and lowering a vehicle jack which may be easily and efficiently manufactured and marketed.

It is another object of the present invention to provide an apparatus for raising and lowering a vehicle jack which is of durable and reliable construction.

It is yet another object of the present invention to provide an apparatus for raising and lowering a vehicle jack which is economically affordable and available for the buying public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a perspective view of the present invention.

FIG. 2 shows a side view of the ratchet of the present invention.

FIG. 3 shows a side view of the socket of the present invention.

FIG. 4 shows a side view of the bolt adapter of the present invention.

### V. DESCRIPTION OF THE PREFERRED EMBODIMENT

FIG. 1 shows a perspective view of the present invention. As can be seen, the present invention is comprised of ratchet 2, socket 4, and bolt adapter 6. The present invention concerns that of a new and improved apparatus which would allow a user to more easily raise and lower a standard jack of a vehicle. Presently, it is awkward for most people to use the jack handle that comes as a standard part of all vehicles. The jack handle that presently comes with vehicles can be turned a little over 180 degrees, at which time, the handle of the jack handle must be brought back toward the person's body, at which time, the jack handle is attached to the jack again and the motion is repeated. A traditional jack handle must be constantly used, detached, re-attached, and used again approximately 20-30 times before the jack would be an appropriate level for a user to change a tire or perform other desired car repairs or alterations.

The present invention would combine the beneficial aspects of a jack handle, along with the beneficial aspects of a ratchet wrench, to allow a user to properly raise or lower a vehicle jack without ever having the need to attach or detach the present invention from the jack until the necessary height had been reached.

Ratchet 2 would also have a handle 8 attached to its lower end which would allow a user to properly grasp the present invention. Handle 8 would have a lower portion 10 which would be removable. Lower portion 10 would preferably be a tight-fitting plastic cap. Handle 8 would have attached to its lower end a hubcap remover 12 which would assist a user in removing hubcaps. Hubcap remover 12 would normally be covered by lower portion 10 of handle 8.

The present invention, when properly used, would be safer than a traditional jack handle because it would allow a user to perform necessary tire changes and/or repairs faster, which would allow a user to spend less time in a potentially dangerous situation on the side of a road or other hazardous location. Further, the present invention would be less tiresome for a user.

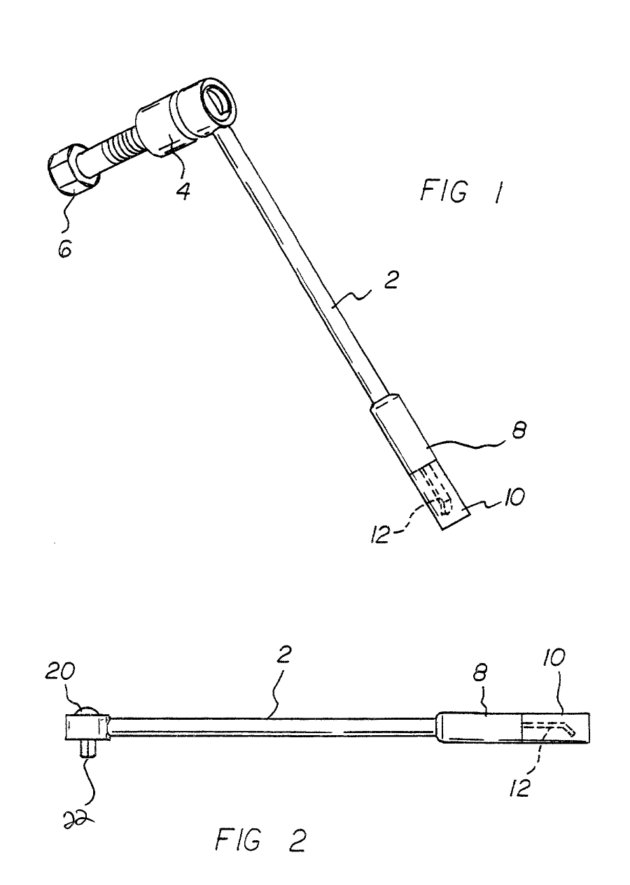

FIG. 2 shows a side view of ratchet 2 of the present invention. Ratchet has two ends, a first end and a second end. The first end of ratchet 2 has handle 8, with lower portion 10 of handle 8 having been removed so that hubcap remover 12 can be effectively shown. Although ratchet 2 has a specific shape and configuration in FIG. 2, ratchet 2 need not be limited to the exact shape and dimensions seen in this drawing.

The second end of ratchet 2 has two sides, a first side and a second side. The first side of the second end of ratchet 2 is capable of being attached to socket 4 by use of projection 22, while the second side of ratchet 2 has attached bi-directional ratchet switch 20. Bi-directional ratchet switch 20 would allow a user to configure ratchet 2 to either tighten or loosen, depending on the specific need for a particular task at hand. Projection 22 would preferably be a square-shaped projection and would preferably have a diameter of approximately one-fourth of an inch, which is the most common diameter for use with ratchet wrenches in use.

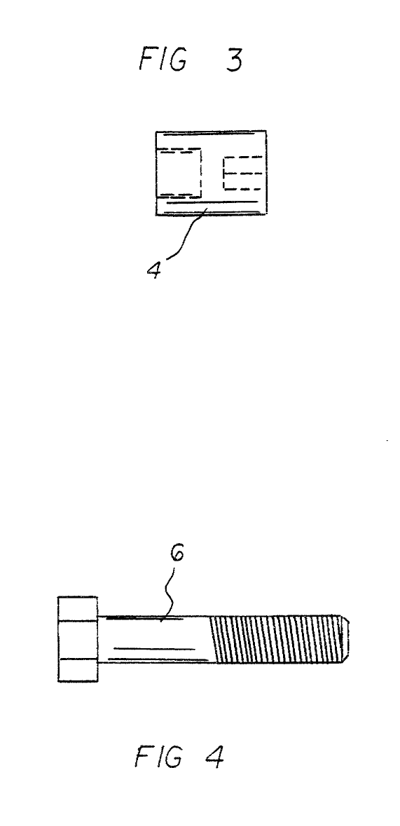

FIG. 3 shows a side view of socket 4 of the present invention. Although socket 4 has a specific shape and configuration in FIG. 3, socket 4 need not be limited to the exact shape and dimensions seen in this drawing.

FIG. 4 shows a side view of the bolt adapter 6 of the present invention. Although bolt adapter 6 has a specific shape and configuration in FIG. 3, bolt adapter 6 need not be limited to the exact shape and dimensions seen in this drawing. Bolt adapter 6 would be capable of removably attaching to socket 4, preferably by threaded means. Bolt adapter 6 would be the portion of the present invention that would placed directly against a vehicle jack when raising or lowering the jack.

What I claim as my invention is:

1. A new and improved tool for raising and lowering a vehicle jack comprising:
(a) a ratchet with two ends, a first end and a second end,
(b) a handle attached to the first end of the ratchet,
(c) a head assembly attached to the second end of the ratchet, the head assembly having two sides, a front side and a rear side,
(d) a bidirectional ratchet switch attached to the rear side of the head assembly of the ratchet,
(e) a projection centrally mounted on the front side of the head assembly, the projection having a square cross-sectional shape,
(f) a socket removably attached to the projection,
(g) a bolt adapter with two ends, a first end and a second end, the first end of the bolt adapter removably attached to the socket, the second end of the bolt adapter capable of removably connecting to a vehicle jack.

2. A new and improved tool for raising and lowering a vehicle jack according to claim 1 wherein the second end of the ratchet further comprises:
(a) a hubcap remover apparatus attached to the second end of the ratchet, the hubcap remover apparatus configured to help a user remove a hubcap, and
(b) a cover to envelop the hubcap remover apparatus, the cover being part of the handle when placed over the hubcap remover apparatus.

3. A new and improved tool for raising and lowering a vehicle jack according to claim 2 wherein the length of the square cross-sectional shape of the projection is preferably one-fourth of an inch.

4. A new and improved tool for raising and lowering a vehicle jack according to claim 2 wherein the first end of the bolt adapter would be attached to the socket via threaded means.
